(19) United States
(12) Patent Application Publication
(10) Pub. No.: US 2026/0066277 A1
(43) Pub. Date: Mar. 5, 2026

(54) COMPOSITE POSITIVE ELECTRODE ACTIVE MATERIAL FOR ALL-SOLID-STATE BATTERY, POSITIVE ELECTRODE INCLUDING THE SAME

(71) Applicant: UIF (University Industry Foundation), Yonsei University, Seoul (KR)

(72) Inventors: Yoon Seok Jung, Seoul (KR); Juhyoun Park, Bucheon-si (KR); Jun Pyo Son, Seoul (KR)

(21) Appl. No.: 19/311,759

(22) Filed: Aug. 27, 2025

(30) Foreign Application Priority Data
Aug. 30, 2024 (KR) 10-2024-0118085
Aug. 20, 2025 (KR) 10-2025-0116061

(51) Int. Cl. H01M 4/36; H01M 4/02; H01M 4/131; H01M 4/505; H01M 4/525; H01M 10/0525; H01M 10/0562

(52) U.S. Cl. CPC H01M 4/366; H01M 4/131; H01M 4/505; H01M 4/525; H01M 10/0525; H01M 10/0562; H01M 2004/021; H01M 2004/028; H01M 2220/20; H01M 2300/008

(57) ABSTRACT

A composite positive electrode active material for an all-solid-state battery, a positive electrode including the composite positive electrode active material, and an all-solid-state battery. The composite positive electrode active material for includes a positive electrode active material core and a coating layer on the core, wherein the coating layer includes an amorphous solid electrolyte represented by Chemical Formula 1:

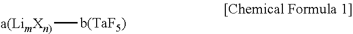

wherein in Chemical Formula 1,
X is F, Cl, Br, I, O, OH, PF₆, BF₄, S, N, P, ClO₄, or CO₃;
m and n satisfy 1≤m≤2 and 1≤n≤2, respectively; and
a and b each satisfy 0.01≤a≤1 and 0.01≤b≤1.

### CROSS-REFERENCE TO RELATED APPLICATION

This application claims priority to and the benefit of Korean Patent Application No. 10-2024-0118085 filed with the Korean Intellectual Property Office on Aug. 30, 2024, and Korean Patent Application No. 10-2025-0116061 filed with the Korean Intellectual Property Office on Aug. 20, 2025, the entire contents of which are incorporated herein by reference.

### BACKGROUND OF THE INVENTION

### (a) Field of the Invention

A composite positive electrode active material for an all-solid-state battery, a positive electrode including the same, and an all-solid-state battery are disclosed.

### (b) Description of the Related Art

Lithium ion batteries are widely used in various applications from portable devices such as smart phones and laptops to electric vehicles and energy storage systems (ESS) due to high energy density and long cycle-life characteristics. Despite such commercial successes of the lithium ion batteries, the lithium ion batteries, which are based on conventional liquid electrolytes, have a limitation in securing safety due to problems such as flammability, a leakage, thermal instability, and the like.

To overcome the limitation, all-solid-state batteries (ASSBs) using all solid electrolytes are attracting attention as a next-generation battery technology. In particular, sulfide-based solid electrolytes are highlighted to be the most promising materials for the all-solid-state batteries due to high ionic conductivity and flexible mechanical characteristics. However, the sulfide-based electrolytes are so electrochemically instable as to cause serious side reactions, when in direct contact with positive electrode active materials with a high voltage (a level of 5 V).

As an approach to solving this problem, research is actively being conducted to secure electrochemical stability by forming a coating layer of oxide- or halide-based materials on the positive electrode active material surface. However, the conventional oxide-based coatings have a problem of hindering ion diffusion within an electrode due to low ionic conductivity and thus reducing battery performance. In addition, some fluoride-based materials provide high oxidation stability but have limitations due to insufficient structural stability and ionic conductivity.

### SUMMARY OF THE INVENTION

An embodiment is to provide a composite positive electrode active material having excellent structural stability and electrochemical characteristics.

An embodiment provides a composite positive electrode active material for an all-solid-state battery including a positive electrode active material core and a coating layer on the core, wherein the coating layer includes an amorphous solid electrolyte represented by Chemical Formula 1:

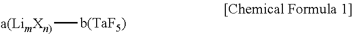

wherein, in Chemical Formula 1,
X is F, Cl, Br, I, O, OH, PF₆, BF₄, S, N, P, ClO₄, or CO₃;
m and n satisfy 1≤m≤2 and 1≤n≤2, respectively; and
a and b each satisfy 0.01≤a≤1 and 0.01≤b≤1.

An embodiment provides a positive electrode including a composite positive electrode active material,
wherein the composite positive electrode active material includes a core including a positive electrode active material and a coating layer on the core, and the coating layer includes an amorphous solid electrolyte represented by Chemical Formula 1:

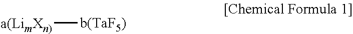

wherein, in Chemical Formula 1,
X is F, Cl, Br, I, O, OH, PF₆, BF₄, S, N, P, ClO₄, or CO₃;
m and n satisfy 1≤m≤2 and 1≤n≤2, respectively; and
a and b each satisfy 0.01≤a≤1 and 0.01≤b≤1.

An embodiment provides an all-solid-state battery including the positive electrode described above; a negative electrode; and a solid electrolyte layer between the positive electrode and the negative electrode.

The composite positive electrode active material according to an exemplary embodiment has excellent structural stability and electrochemical characteristics, and can greatly improve the charge/discharge characteristics and cycle-life characteristics of an all-solid-state battery using the composite positive electrode active material as the positive electrode.

### BRIEF DESCRIPTION OF THE DRAWINGS

FIG. 1 is a cross-sectional view of an all-solid-state battery according to an embodiment.

FIG. 2 shows (a) powder XRD patterns of amorphous solid electrolytes of Synthetic Examples 1 to 6, along with Bragg reflections for LiTaF₆ shown at the bottom, and (b) Arrhenius plots of amorphous solid electrolytes of Synthesis Examples 1 and 6 for Li⁺ conductivity.

FIG. 3 shows (a) PDF patterns of amorphous solid electrolytes of Synthesis Examples 1 to 6 and (b) soft XAFS profiles of amorphous solid electrolytes of Synthesis Examples 1 and 6.

FIG. 4 shows (a, b) the long-term cycle performance and corresponding charge-discharge profiles at 1.0 C of each all-solid-state battery cell using the composite positive electrode active materials of Examples 1 and 6, and (c, d) the discharge capacity and coulombic efficiency according to the number of cycles of each all-solid-state battery cell using the composite positive electrode active materials of Examples 1 and 6, having an area capacity of 6 mA cm⁻² or more cycled at 0.1 C (0.592 mA cm⁻²) at room temperature.

FIG. 5 shows (a, b) the cell performance and corresponding charge-discharge profile of an all-solid-state battery cell using the positive electrode active material of Comparative Example 1.

FIG. 6 shows (a, b) the cell performance and corresponding charge-discharge profile of an all-solid-state battery cell using the composite positive electrode active material of Comparative Example 2.

### DETAILED DESCRIPTION OF THE EMBODIMENTS

Hereinafter, example embodiments will hereinafter be described in detail, and may be easily performed by a person having an ordinary skill in the related art. However, this disclosure may be embodied in many different forms and is not to be construed as limited to the exemplary embodiments set forth herein.

In the drawings, the thickness of layers, films, panels, regions, etc., are exaggerated for clarity. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In the drawings, parts having no relationship with the description are omitted for clarity, and the same or similar constituent elements are indicated by the same reference numeral throughout the specification.

Hereinafter, the terms “lower portion” or “under” and “upper portion” or “on” are for convenience of description and do not limit the positional relationship.

Hereinafter, unless otherwise defined, ‘metal’ includes metal and semimetal.

As used herein, “combination thereof” means a mixture, a laminate, a composite, a copolymer, an alloy, a blend, a reaction product, and the like of the constituents.

Hereinafter, a composite positive electrode active material according to an embodiment is described.

### Composite Positive Electrode Active Material

An embodiment provides a composite positive electrode active material for an all-solid-state battery including a positive electrode active material core and a coating layer on the core, wherein the coating layer includes an amorphous solid electrolyte represented by Chemical Formula 1:

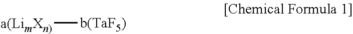

wherein each symbol in Chemical Formula 1 follows a detailed description below.

A composite positive electrode active material according to an embodiment includes a positive electrode active material in which an amorphous solid electrolyte having excellent structural stability and electrochemical characteristics is coated on the surface of the positive electrode active material.

This can greatly improve the charge/discharge characteristics and cycle-life characteristics of an all-solid-state battery compared to not only a bare positive electrode active material but also a positive electrode active material coated with a conventional crystalline solid electrolyte on its surface.

Hereinafter, a composite positive electrode active material according to an embodiment is described in detail.

### Coating Layer (Amorphous Solid Electrolyte)

In a composite positive electrode active material according to an embodiment, the description of the amorphous solid electrolyte (Chemical Formula 1) constituting the coating layer is as follows.

In Chemical Formula 1, X is F, Cl, Br, I, O, OH, PF₆, BF₄, S, N, P, ClO₄, or CO₃; and m and n may satisfy 1≤m≤2 and 1≤n≤2, respectively. Here, m and n may be determined by considering the stoichiometric molar ratio of Li and X. For example, in Chemical Formula 1, LiₘXₙ may be LiF, LiCl, LiBr, LiI, Li₂O, Li₂O₂, Li₂CO₃, LiOH, LiPF₆, LiBF₄, Li₂S, Li₃N, Li₃P, LiClO₄, or a combination thereof.

In Chemical Formula 1, a and b are each 0.01≤a≤1 and 0.01≤b≤1. Here, a and b may be determined by considering the stoichiometric molar ratio of LiₘXₙ and TaF₅.

The amorphous solid electrolyte represented by Chemical Formula 1 may be formed by a process of mechanically milling a raw material mixture including LiX¹ (wherein, X¹═F, Cl, Br, I, O, OH, PF₆, BF₄, S, N, P, ClO₄, or a combination thereof) and TaF5. Optionally, the raw material mixture may further comprise Li₂O.

In the process of mechanically milling the raw material mixture, a mechanochemical reaction occurs, and as a result, the compound represented by Chemical Formula 1 may be formed.

Representative examples of the amorphous solid electrolyte represented by Chemical Formula 1 may be LiTaF₆, Li_{1.2}TaO_{0.2}F_{5.8}, Li_{1.4}TaO_{0.4}F_{5.6}, Li_{1.6}TaO_{0.6}F_{5.4}, Li_{1.8}TaO_{0.8}F_{5.2}, Li₂TaOF₅, or a combination thereof.

The lithium ionic conductivity at 30° C. of the amorphous solid electrolyte represented by Chemical Formula 1 may be greater than or equal to about 1.0×10⁻¹⁰ S/cm, for example, greater than or equal to about 1.0×10⁻⁹ S/cm, greater than or equal to about 1.0×10⁻⁸ S/cm, greater than or equal to about 1.0×10⁻⁷ S/cm, or greater than or equal to about 1.0×10⁻⁶ S/cm, and there is no upper limit.

In an embodiment, the coating layer may be included in an amount of about 1 part by weight to about 50 parts by weight, for example, about 20 parts by weight or about 30 parts by weight, based on 100 parts by weight of the total amount of the composite positive electrode active material.

When the above numerical ranges are satisfied, a composite positive electrode active material having both excellent electrochemical stability and ionic conductivity may be realized.

### Core (Positive Electrode Active Material)

In a composite positive electrode active material according to an embodiment, the positive electrode active material constituting the core may include a lithium-rich positive electrode active material or a high-nickel (high-Ni) positive electrode active material.

For example, the positive electrode active material may include a lithium nickel-based oxide, a lithium cobalt-based oxide, a lithium manganese-based oxide, a lithium iron phosphate-based compound, a cobalt-free lithium nickel-manganese oxide, or a combination thereof, and for example, may include lithium nickel oxide (LNO), lithium cobalt oxide (LCO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), lithium iron phosphate (LFP), or a combination thereof.

For example, the positive electrode active material may include a spinel-based positive electrode active material, and the spinel-based positive electrode active material may include a compound represented by Chemical Formula 2A.

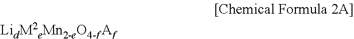

In Chemical Formula 2A,
M² is Al, Ni, Co, Mn, Zn, Cr, Mg, Sr, V, Ca, Ti, Y, Zr, Nb, Mo, Hf, Ta, W, Na, Sn, a rare-earth element, or a combination thereof,
A is F, Cl, Br, or I,
1≤d≤2, 0≤e<2, and 0≤f<4.

For example, the positive electrode active material may include a layered positive electrode active material, and the layered positive electrode active material may include a compound represented by Chemical Formula 2B.

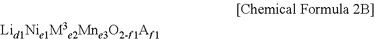

In Chemical Formula 2B,
M³ is Al, Co, Mn, Zn, Cr, Fe, Mg, Sr, V, Ca, Ti, Y, Zr, Nb, Mo, Hf, Ta, W, Na,
Sn, rare-earth element, or a combination thereof,
A is F, Cl, Br, I, S, P, or a combination thereof,
1≤d1≤2, 0<e1≤1, 0<e2≤1, 0<e3≤1, and 0≤f1<2.

As a specific example, the positive electrode active material may include LiNi_{0.5}Mn_{1.5}O₄, LiCoMnO₄, or a combination thereof.

For example, the positive electrode active material may be in the form of particles, and the positive electrode active material may include a single crystal, a polycrystal formed by an aggregate thereof, or a combination thereof.

The single crystal may mean a minimum unit of particles constituting the positive electrode active material, and may mean a minimum unit judged from the external geometric shape.

The average particle size (D50) of the positive electrode active material in single crystal form may be about 4 μm to about 10 μm, for example, about 5 μm to about 10 μm, or about 5 μm to about 8 μm.

The average particle size (D50) of the positive electrode active material in polycrystalline form may be about 10 μm to about 20 μm, for example, about 12 μm to about 20 μm, or about 12 μm to about 18 μm.

Here, the average particle size may be obtained by selecting 20 or so random particles from a scanning electron microscope image of the positive electrode active material, measuring their particle sizes (diameter, major axis, or major axis length), obtaining a particle size distribution, and then taking the diameter (D50) of the particles having a cumulative volume of 50 volume % from the particle size distribution as the average particle size.

### Method of Preparing Composite Positive Electrode Active Material

Hereinafter, a method for preparing a composite positive electrode active material is described.

A method of preparing a composite positive electrode active material according to an embodiment includes: (1) preparing the compound represented by Chemical Formula; and (2) mixing the positive electrode active material and the compound in a solid phase and coating the compound on the surface of the positive electrode active material.

First, the step (1) of preparing the compound represented by Chemical Formula 1 may include a step of solid-phase mixing a raw material mixture including LiX¹ (wherein, X¹═F, Cl, Br, I, O, OH, PF₆, BF₄, S, N, P, ClO₄, or a combination thereof) and TaF₅.

The raw material mixture may be mixed in a stoichiometric molar ratio according to a desired chemical formula. The raw material mixture may further include a lithium oxide, and the lithium oxide may be Li₂O

The solid-phase mixing of the raw material mixture may be performed by one mechanical milling selected from a ball mill, a vibration mill, a turbo mill, a mechanofusion mill, and a disk mill and desirably, a ball mill or a vibration mill.

For example, the mechanical milling can be performed at a rotation speed of about 300 to about 800 rpm. For example, the mechanical milling may be performed for about 10 to about 50 hours, and as a specific example, it may be performed for about 7 to about 18 hours at a rotation speed of about 500 to about 700 rpm, and as a most specific example, it may be performed for about 9 to about 11 hours at a rotation speed of about 580 to about 620 rpm.

The positive electrode active material is coated with the compound represented by Chemical Formula 1 prepared above (step (2)).

The positive electrode active material is as described above, and a detailed description is omitted here.

In the step (2) of coating the compound on the surface of the positive electrode active material, the coating may be performed by any one mechanical milling selected from a ball mill, a vibration mill, a turbo mill, a mechanofusion, and a disk mill, and may desirably be performed by a ball mill or a vibration mill.

For example, the mechanical milling may be performed at a rotation speed of about 100 to about 800 rpm for about 0.5 to about 10 hours, specifically at a rotation speed of about 200 to about 300 rpm for about 0.5 to about 3 hours, and most specifically at a rotation speed of about 180 to about 230 rpm for about 0.5 to about 1 hour.

### All-Solid-State Battery

Another embodiment provides an all-solid-state battery including a positive electrode including the composite positive electrode active material; a negative electrode; and a solid electrolyte between the positive electrode and the negative electrode.

When the composite positive electrode active material is applied to an all-solid-state battery, an all-solid-state battery with excellent performance in terms of charge/discharge characteristics and cycle-life characteristics may be realized.

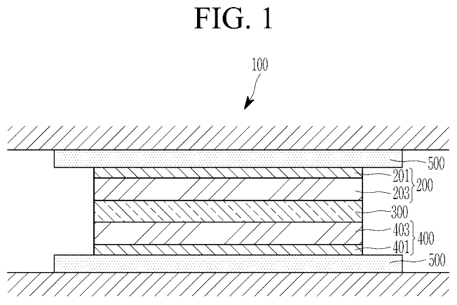

Hereinafter, an all-solid-state battery is described with reference to FIG. 1.

FIG. 1 is a cross-sectional view of an all-solid-state battery according to an embodiment. Referring to FIG. 1, the all-solid-state battery 100 may have a structure that an electrode assembly, in which a negative electrode 400 including a negative current collector 401 and a negative electrode active material layer 403, a solid electrolyte layer 300, and a positive electrode 200 including a positive electrode active material layer 203 and a positive current collector 201 are stacked, is inserted into a case such as a pouch. The all-solid-state battery 100 may further include at least one elastic layer 500 on the outside of at least either one of the positive electrode 200 and the negative electrode 400. FIG. 1 shows one electrode assembly including the negative electrode 400, the solid electrolyte layer 300, and the positive electrode 200, but two or more electrode assemblies may be stacked to manufacture an all-solid-state battery.

Also, as a device including an all-solid-state battery according to an embodiment may be any one selected from a communication device, a transportation device, and an energy storage device.

Also, as an electric device including an all-solid-state battery according to an embodiment, the electric device may be one selected from electric vehicles, hybrid electric vehicles, plug-in hybrid electric vehicles, and power storage devices.

The charge voltage of the all-solid-state battery according to an embodiment may be greater than or equal to about 4.2 V, for example greater than or equal to about 4.5 V, greater than or equal to about 4.6 V, greater than or equal to about 4.8 V, or greater than or equal to about 5 V.

The discharge voltage of the all-solid-state battery according to one embodiment may be less than or equal to about 3.5 V, for example less than or equal to about 3.0 V, less than or equal to about 2.5 V, or less than or equal to about 2.3 V.

An all-solid-state battery satisfying the above numerical ranges of charge voltage and discharge voltage has the advantage of excellent charge/discharge characteristics and cycle-life characteristics when driven by high-voltage charge or low-voltage discharge.

### Positive Electrode

The positive electrode 200 may include a positive electrode current collector 201 and a positive electrode active material layer 203 on the positive electrode current collector 201.

The positive electrode active material layer 203 includes the composite positive electrode active material and may optionally further include a solid electrolyte.

In an embodiment, the solid electrolyte included in the positive electrode active material layer 203 may include a halide-based solid electrolyte, a sulfide-based solid electrolyte, an oxide-based solid electrolyte, a complex hydride, or a combination thereof, and the types of solid electrolytes that may be included in the positive electrode active material layer 203 will be described later in the section on the solid electrolyte layer.

For example, the solid electrolyte included in the positive electrode active material layer 203 may be a halide-based solid electrolyte, and when the above-described composite positive electrode active material and the halide-based solid electrolyte are used in combination, the high-voltage stability of the all-solid-state battery can be further improved.

For example, a weight ratio of the composite positive electrode active material and the solid electrolyte included in the positive electrode active material layer 203 may be about 30:70 to about 70:30, for example, about 40:60 to about 60:40, or about 45:55 to about 55:45.

### Negative Electrode

The negative electrode 400 may be a general negative electrode including various negative electrode active materials such as carbon-based and silicon-based materials, or may be a negative electrode made of a metal such as lithium metal, and may be a precipitation-type negative electrode in which no negative electrode active material is present initially and lithium metal or the like is precipitated during charging to serve as a negative electrode active material.

For example, the negative electrode 400 may include a negative electrode current collector 401 and a negative electrode active material layer 403 on the negative electrode current collector 401. The negative electrode active material layer 403 may include a negative electrode active material and optionally may include a solid electrolyte. The solid electrolyte that may be included in the negative electrode active material layer 203 will be described later in the section on the solid electrolyte layer.

The negative electrode active material may include a material capable of reversibly intercalating/deintercalating lithium ions, lithium metal, an alloy of lithium metal, a material capable of doping and dedoping lithium, or a transition metal oxide.

The material capable of reversibly intercalating/deintercalating lithium ions is a carbon-based negative electrode active material, and may include, for example, crystalline carbon, amorphous carbon, or a combination thereof. Examples of crystalline carbon include natural graphite, artificial graphite, or a combination thereof, and examples of amorphous carbon include soft carbon or hard carbon, a mesophase pitch carbonized product, and calcined coke. The carbon-based negative electrode active material may have irregular, plate-like, flake-like, spherical, or fibrous shape.

The lithium metal alloy may be an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping and dedoping the lithium may be a Si-based negative electrode active material or a Sn-based negative electrode active material. The Si-based negative electrode active material may include silicon, a silicon-carbon composite, SiOₓ (0<x<2), a silicon alloy, etc., and the Sn-based negative electrode active material may include Sn, SnO₂, a tin alloy, etc., and at least one of these can be mixed and used with SiO₂. For example, the negative electrode active material may include a composite of silicon and carbon.

### Solid Electrolyte Layer

The solid electrolyte layer 300 includes a solid electrolyte, and the solid electrolyte may include a sulfide-based solid electrolyte.

The sulfide-based solid electrolyte may be divided into a crystalline solid electrolyte and a non-crystalline solid electrolyte depending on the presence or absence of a crystal structure. Representative crystalline solid electrolyte may include Thio-LISICON such as Li_{3.25}Ge_{0.25}P_{0.75}S₄, LGPS such as Li₁₀GeP₂S₁₂, and argyrodite structure such as Li₆PS₅Cl. The non-crystalline solid electrolyte may be divided into a glass-based solid electrolyte and a glass-ceramic-based solid electrolyte depending on the difference in heat treatment temperature. Examples of the glass-based solid electrolyte may include 30Li₂S·26B₂S₃·44LiO, 63Li₂S·36SiS₂·1Li₃PO₄, 57Li₂S·38SiS₂·5Li₄SiO₄, and examples of glass-ceramic-based solid electrolyte include Li_{3.25}P_{0.95}S₄, Li₇P₃S₁₁, etc.

The sulfide-based solid electrolyte may be classified into an argyrodite structure, a binary structure such as Li₂S—P₂S₅, and a ternary structure such as Li₂S—GeS₂—P₂S₅.

The sulfide-based solid electrolyte may be an argyrodite-type sulfide-based solid electrolyte. The argyrodite is one of the solid electrolytes that exhibits lithium ionic conductivity and has the same structure as the mineral Ag₉GeS₆. Li-argyrodite with Lit conductivity may typically be Li₂PS₆ and Li₆PS₅X (X═Cl, Br, or I). Common methods for synthesizing the argyrodite-type sulfide-based solid electrolyte may include mechanical milling, post-milling annealing, solid-state sintering, and liquid-phase methods.

It has been reported that Li₇PS₆, that is an argyrodite type, has a cubic phase at a high temperature, an orthorhombic phase at a low temperature, and a cubic phase at a high temperature, which exhibits improved ionic conductivity. This compound can be stabilized by substituting sulfur with a halogen anion. As the halogen element is substituted, a vacancy is formed in the lithium site portion inside the argyrodite unit cell, which improves the lithium ionic conductivity. Due to the substitution of the halogen ion, the cubic phase is stabilized even at room temperature, so that, for example, Li₆PS₅Br and Li₆PS₅Cl can exhibit high ionic conductivities of greater than or equal to about 10⁻³ S/cm.

For example, the argyrodite-type sulfide-based solid electrolyte may include Li₇PS₅Br, Li₅PS₄Cl₂, Li₆PS₅Cl, Li₆PS₅Br, Li₆PS₅I, Li₇P₂S₈I, Li₄PS₄I, Li_{9.54}Si_{1.74}P_{1.44}S_{11.7}Cl_{0.3}, Li₇P_{2.9}Mn_{0.1}S_{10.7}I_{0.3}, or a combination thereof, but is not limited thereto.

For example, the sulfide-based solid electrolyte may include Li_{7+x-y}Mₓ⁴⁺M₁₋ₓ⁵⁺S_{6-y}X_{y} (M⁴⁺: Si, Ge, S or Sn; M⁵⁺: P or Sb; X: CI, Br, or I, 0<x≤1, 0≤y≤2), Li₁₀₊ₐ[Ge_{b}M⁴⁺_{1-b}]₁₊ₐP₂ₐS_{12-c}X_{c} (M⁴⁺: Si or Sn; X: CI, Br, or I, 0≤a≤2, 0≤b≤1, 0≤c≤4), or a combination thereof.

The sulfide-based solid electrolyte is in the form of particles and may have an average particle diameter (D₅₀) of less than or equal to about 5.0 μm, for example, about 0.1 μm to about 5.0 μm, about 0.5 μm to about 5.0 μm, about 0.5 μm to about 4.0 μm, about 0.5 μm to about 3.0 μm, about 0.5 μm to about 2.0 μm, or about 0.5 μm to about 1.0 μm. The sulfide-based solid electrolyte may achieve high ionic conductivity and have excellent contact with the positive electrode active material and connectivity between solid electrolyte particles.

The above solid electrolyte layer 300 may further include a solid electrolyte other than the sulfide-based solid electrolyte, and may further include, for example, an oxide-based solid electrolyte, a halide-based solid electrolyte, a complex hydride, or a combination thereof.

The oxide-based solid electrolyte may include, for example Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y} PO₄₃, 0<x<2, 0<y<3), Li_{1+x+y}(Al,Ga)ₓ(Ti,Ge)₂₋ₓSi_{y}P_{3-y}O₁₂ (0≤x≤1, 0≤y≤1), lithium titanium phosphate (LiₓTi_{y}(PO₄)₃, 0<x<2, 0<y<3), Li₂O, LiAlO₂, Li₂O—Al₂O₃—SiO₂—P₂O₅—TiO₂—GeO₂ ceramics, garnet-type ceramics Li₃₊ₓLa₃M₂O₁₂ (M=Te, Nb, or Zr, and x is an integer from 1 to 10), or a combination thereof.

The halide-based solid electrolyte includes a halogen element as a main component, and a ratio of the halogen element to all elements constituting the solid electrolyte may be greater than or equal to about 50 mol %, greater than or equal to about 70 mol %, greater than or equal to about 90 mol %, or 100 mol %.

The halide-based solid electrolyte may include a lithium element, a metal element other than lithium, and a halogen element. The metal element other than lithium may be, for example, Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof. The halogen element may be F, Cl, Br, I, or a combination thereof, for example CI, Br, or a combination thereof.

For example, the halide-based solid electrolyte may include at least one of the compounds represented by Chemical Formula 3 to Chemical Formula 6.

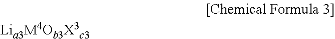

In Chemical Formula 3,

M⁴ may be Al, As, B, Bi, Ca, Cd, Co, Cr, Fe, Ga, Hf, In, Mg, Mn, Nb, Ni, Sb, Sc, Sn, Ta, Ti, Y, Yb, Zn, Zr, or a combination thereof,
X³ may be F, Cl, Br, I, or a combination thereof, and
1≤a3≤3, 0≤b3≤1, and 4≤c3≤6.

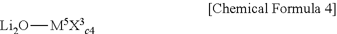

In Chemical Formula 4,
M⁵ may be Al, As, B, Bi, Ca, Cd, Co, Cr, Fe, Ga, Hf, In, Mg, Mn, Nb, Ni, Sb, Sc, Sn, Ta, Ti, Y, Yb, Zn, Zr, or a combination thereof, and
X³ may be F, Cl, Br, I, or a combination thereof, and 4≤c4≤6.

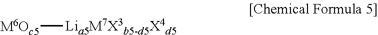

In Chemical Formula 5,
M⁶ and M⁷ may be the same or different and may each independently be Mg, Ca, Zn, Cd, Cu, Sc, Y, B, Al, Ga, In, Ln, La, Ce, Pr, Nd, Pm, Sm, Eu, Gd, Tb, Dy, Ho, Er, Yb, Lu, Ti, Zr, Hf, Nb, Ta, Mo, W, Sb, Si, Ge, Sn, V, Cr, Mn, Fe, Co, Ni, or a combination thereof,
X³ and X⁴ may be different and may each independently be CI, Br, F, or I, and
0.01≤a5≤10, 0.01≤b5≤10, 0.01≤c5≤10, and 0.01≤d5≤4.

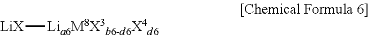

In Chemical Formula 6,
M⁸ may be Mg, Ca, Zn, Cd, Cu, Sc, Y, B, Al, Ga, In, Ln, La, Ce, Pr, Nd, Pm, Sm, Eu, Gd, Tb, Dy, Ho, Er, Yb, Lu, Ti, Zr, Hf, Nb, Ta, Mo, W, Sb, Si, Ge, Sn, V, Cr, Mn, Fe, Co, Ni, or a combination thereof,
X may be Cl, Br, F, or I,
X³ and X⁴ may be different and may each independently be Cl, Br, F, or I, and
0.01≤a6≤10, 0.01≤b6≤10, 0.01≤c6≤10, and 0.01≤d6≤4.

For example, the halide-based solid electrolyte may include Li₂ZrCl₆, Li_{2.7}Y_{0.7}Zr_{0.3}Cl₆, Li_{2.5}Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{2.6}Hf_{0.4}Yb_{0.6}Cl₆, LiAlCl₄, LiNbOCl₄, LiTaOCl₄, or a combination thereof.

For example, the halide-based solid electrolyte may be Li₂ZrCl₆, Li_{2.7}Y_{0.7}Zr_{0.3}Cl₆, Li_{2.5}Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{2.6}Hf_{0.4}Yb_{0.6}Cl₆, LiAlCl₄, LiNbOCl₄, LiTaOCl₄, Li₂O—TaCl₅, MgO—Li₂ZrCl₆, Al₂O₃₋₃Li₂ZrCl₆, Al₂O₃₋₂Li₃YCl₆, Al₂O₃₋₃Li₂ZrCl₆, 3ZrO₂-4Li₃YCl₆, ZrO₂-2Li₂ZrCl₆, ZrO₂-2Li₂ZrCl₅F, SiO₂-2Li₂ZrCl₆, SnO₂-2Li₂ZrCl₆, or a combination thereof,

The complex hydride may be, for example, MM′Hₙ composed of a metal cation (M) and a complex-anion M′Hₙ. The metal cation (M) may be, for example, Li, Na, K, Mg, Sc, Cu, Zn, Zr, or Hf, and the complex-anion can be [BH₄]⁻, [NH₂]⁻, [AlH₄]⁻, [NH]²⁻, [AlH₆]³⁻, or [NiH₄]⁴⁻. The complex hydride may be referred to the reference “M. Matsuo, S.-i. Orimo, Adv. Energy Mater. 2011, 1, 161.”

Hereinafter, various examples and experimental examples of the present invention will be described in detail. However, the following examples are merely some examples of the present invention, and the present invention should not be construed as being limited to the following examples.

### Synthesis Example 1: Amorphous LiTaF₆

TaF₅ and LiF were first weighed to be included in a stoichiometric molar ratio of LiTaF₆ and then, mechanically milled at 600 rpm for 10 hours in a 50 ml ZrO₂ vial with 15 ZrO₂ balls (φ=10 mm) under an Ar atmosphere by using Pulverisette 7 PL (Fritsch GmbH) to synthesize amorphous LiTaF₆.

### Example 1: LiNi_{0.5}Mn_{1.5}O₄ Coated with Amorphous LiTaF₆

A composite positive electrode active material was prepared by coating the amorphous LiTaF₆ on the surface of LiNi_{0.5}Mn_{1.5}O₄ under the same condition as in Synthesis Example 1 except that the amorphous LiTaF₆ was weighed to be included in an amount of 20 parts by weight based on 100 parts by weight of the core and then, mechanically milled at 200 rpm for 1 hour.

### Synthesis Example 2: Amorphous Li_{1.2}TaO_{0.2}F_{5.8}

Li₂O, TaF₅, and LiF were first weighed to be included in a stoichiometric molar ratio of Li_{1.2}TaO_{0.2}F_{5.8} and then, mechanically milled at 600 rpm for 10 hours in a 50 ml ZrO₂ vial with 15 ZrO₂ balls (φ=10 mm) under an Ar atmosphere by using Pulverisette 7 PL (Fritsch GmbH) to synthesize amorphous Li_{1.2}TaO_{0.2}F_{5.8}.

### Example 2: LiNi_{0.5}Mn_{1.5}O₄ Coated with Amorphous Li_{1.2}TaO_{0.2}F_{5.8}

A composite positive electrode active material, in which the surface of LiNi0.5Mn1.5O4 was coated with amorphous Li_{1.2}TaO_{0.2}F_{5.8}, was prepared under the same conditions as in Synthesis Example 2, except that the amorphous Li_{1.2}TaO_{0.2}F_{5.8} was weighed to be included in an amount of 20 parts by weight based on 100 parts by weight of the core, and then mechanically milled at 200 rpm for 1 hour.

### Synthesis Example 3: Amorphous Li_{1.4}TaO_{0.4}F_{5.6}

Amorphous Li_{1.4}TaO_{0.4}F_{5.6} was synthesized in the same manner as in Synthesis Example 2 except that the ratio of Li₂O, TaF₅, and LiF were changed to a stoichiometric molar ratio of the amorphous Li_{1.4}TaO_{0.4}F_{5.6}.

### Example 3: LiNi_{0.5}Mn_{1.5}O₄ Coated with Amorphous Li_{1.4}TaO_{0.4}F_{5.6}

A composite positive electrode active material, in which the surface of LiNi_{0.5}Mn_{1.5}O₄ was coated with amorphous Li_{1.4}TaO_{0.4}F_{5.6}, was prepared in the same manner as in Example 2, except that the amorphous Li_{1.4}TaO_{0.4}F_{5.6} was used instead of the amorphous Li_{1.2}TaO_{0.2}F_{5.8}.

### Synthesis Example 4: Amorphous Li_{1.6}TaO_{0.6}F_{5.4}

Amorphous Li_{1.6}TaO_{0.6}F_{5.4} was synthesized in the same manner as in Synthesis Example 2 except that the ratio of Li₂O, TaF₅, and LiF was changed to a stoichiometric molar ratio of Li_{1.6}TaO_{0.6}F_{5.4}.

### Example 4: LiNi_{0.5}Mn_{1.5}O₄Coated with Amorphous Li_{1.6}TaO_{0.6}F_{5.4}

A composite positive electrode active material, in which the surface of LiNi_{0.5}Mn_{1.5}O₄ was coated with amorphous Li_{1.6}TaO_{0.6}F_{5.4}, was prepared in the same manner as in Example 2, except that the amorphous Li_{1.6}TaO_{0.6}F_{5.4} was used instead of the amorphous Li_{1.2}TaO_{0.2}F_{5.8}.

### Synthesis Example 5: Amorphous Li_{1.8}TaO_{0.8}F_{5.2}

Amorphous Li_{1.8}TaO_{0.8}F_{5.2} was synthesized in the same manner as in Synthesis Example 2 except that the ratio of Li₂O, TaF₅, and LiF was changed to a stoichiometric molar ratio of Li_{1.8}TaO_{0.8}F_{5.2}.

### Example 5: LiNi_{0.5}Mn_{1.5}O₄Coated with Amorphous Li_{1.8}TaO_{0.8}F_{5.2}

A composite positive electrode active material, in which the surface of LiNi_{0.5}Mn_{1.5}O₄ was coated with amorphous Li_{1.8}TaO_{0.8}F_{5.2}, was prepared in the same manner as in Example 2, except that the amorphous Li_{1.8}TaO_{0.8}F_{5.2} was used instead of the amorphous Li_{1.2}TaO_{0.2}F_{5.8}.

### Synthesis Example 6: Amorphous Li₂TaOF₅

Amorphous Li₂TaOF₅ was synthesized in the same manner as in Synthesis Example 2 except that the ratio of Li₂O, TaF₅ and LiF was changed to a stoichiometric molar ratio of Li₂TaOF₅.

### Example 6: LiNi_{0.5}Mn_{1.5}O₄Coated with Amorphous Li₂TaOF₅

A composite positive electrode active material, in which the surface of LiNi_{0.5}Mn_{1.5}O₄ was coated with amorphous Li₂TaOF₅, was prepared in the same manner as in Example 2, except that the amorphous Li₂TaOF₅ was used instead of the amorphous Li_{1.2}TaO_{0.2}F_{5.8}.

### Comparative Example 1 (Ref., Bare)

LiNi_{0.5}Mn_{1.5}O₄ itself without coating was used as a positive electrode active material.

### Comparative Example 2

A composite positive electrode active material was prepared by adding lithium ethoxide and niobium ethoxide to ethanol to have 5 parts by weight of LiNbO₃ based on 100 parts by weight of LiNi_{0.5}Mn_{1.5}O₄, stirring them to prepare a precursor mixture, evaporating the solvent (ethanol) therefrom for 30 minutes with a rotary evaporator, and performing a heat treatment for 1 hour to coat LiNbO₃ on the surface of LiNi_{0.5}Mn_{1.5}O₄.

Evaluation Example 1: XRD of Amorphous Solid Electrolytes of Synthesis Examples 1 to 6

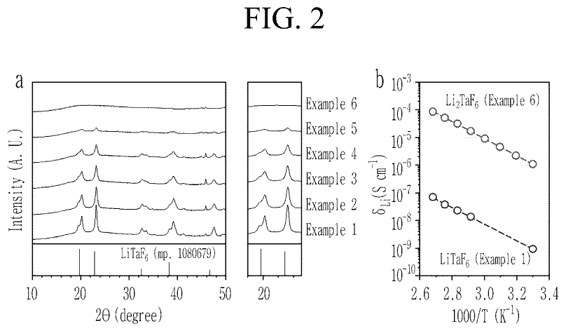

FIG. 2(a) shows powder XRD patterns of the amorphous solid electrolytes of Synthesis Examples 1 to 6 along with Bragg reflections for LiTaF₆ shown at the bottom.

The powder XRD patterns of the amorphous solid electrolytes of Synthesis Examples 1 to 6 were measured at 40 kV and 15 mA by using Rigaku MiniFlex600 diffractometer using Cu Kα radiation (λ=1.5406 Å) and mounting an XRD cell containing a sealed sample with a beryllium (Be) window on the Rigaku MiniFlex600 diffractometer.

According to FIG. 2(a), the X-ray diffraction (XRD) pattern of the amorphous solid electrolyte of Synthesis Example 1 shows an amorphous state with no long-range regularity, but exhibits peaks structurally similar to trigonal LiTaF₆ in the short range. As a molar ratio of oxygen (O) increased from Synthesis Example 1 to Synthesis Example 6, a diffraction peak of LiTaF₆ having R-3 symmetry gradually weakened, and Synthesis Example 6, which had an amorphous Li₂TaOF₅ composition, exhibited no clear diffraction peak, which suggested disruption of long-range order according to the oxygen introduction.

### Evaluation Example 2: Ionic Conductivity of Amorphous Solid Electrolytes of Synthesis Examples 1 and 6

FIG. 2(b) shows Arrhenius plots of the amorphous solid electrolytes of Synthesis Examples 1 and 6 for Li⁺ conductivity.

The ionic conductivity of the amorphous solid electrolytes of Synthesis Examples 1 and 6 was measured in an AC impedance method by using symmetrical all-solid-state battery cells.

(1) Manufacturing of all-Solid-State Battery Cells

All-solid-state battery cells with a diameter of 13 mm were assembled by using a Ti rod and a poly(aryletheretherketone) mold encapsulated with stainless steel as a current collector.

The amorphous solid electrolyte powder of Synthesis Example 1 or Synthesis Example 6 (about 150 mg) was placed in an insulating cylinder and pressed at a pressure of about 380 MPa using a hydraulic press (3850 mini-c, Carver) to prepare a pellet having a thickness of about 600 μm. A symmetrical cell was configured by contacting stainless steel (SUS) electrodes as ion-blocking electrodes to both sides of the prepared pellet.

### (2) Ionic Conductivity

Referring to FIG. 2(b), the amorphous solid electrolyte (Li₂TaOF₅) of Synthesis Example 6 was measured to have lithium ionic conductivity of about 1.08×10⁻⁶ S/cm at 30° C., which was more than 1000 times higher than the extrapolated ionic conductivity of LiTaF₆ (9.20×10⁻¹⁰ S/cm, at 70 to 100° C.).

### Evaluation Example 3: PDF Patterns of Amorphous Solid Electrolytes of Synthesis Examples 1 to 6

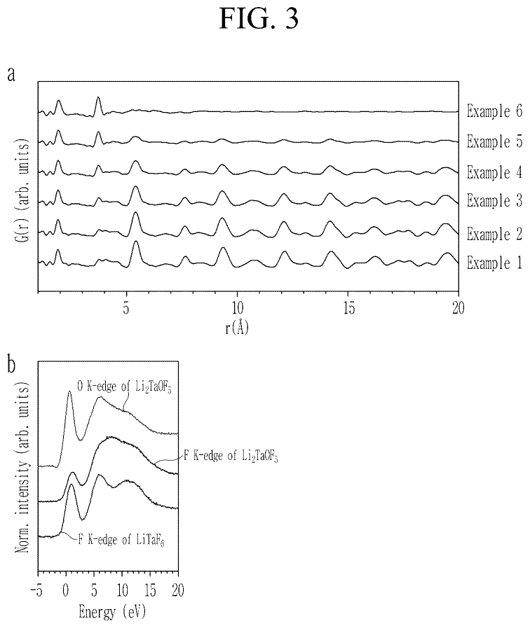

FIG. 3(a) shows PDF patterns of the amorphous solid electrolytes of Synthesis Examples 1 to 6.

The PDF patterns were obtained from 28-ID-1 PDF beamline of a national syncrotron light source II (NSLS II) by using a monochromatic X-ray wavelength of 0.1665 Å. Ceo2 was used calibrate a sample-to-detector distance, and a Dioptas image processing software was used to convert the collected 2D images to a 1D pattern. The PDF G(r) patterns of the amorphous solid electrolytes of Synthesis Examples 1 to 6 were obtained through Fourier transform within a range of 0.1 to 21.0 Å⁻¹ by using a group of xPDF products. The PDF patterns were refined by fitting a scale factor, an atom displacement parameter, and delta2 with a crystalline LiTaF₆ model, wherein the amorphous solid electrolyte of Synthesis Example 6 was excluded.

Referring to FIG. 3(a), the spectra show a slight decrease in intensity of a Ta—O/F first shell, which confirmed that the amorphous solid electrolytes of Synthesis Examples 1 to 6 had a coordination number of 6. In the long-range region, the PDF G(r) of the amorphous solid electrolyte (LiTaF₆) of Synthesis Example 1 was well fitted to a trigonal R-3 phase (Rw=16.5%). Like the XRD results of FIG. 2(a), the amorphous solid electrolyte (Li₂TaOF₅) of Synthesis Example 6 exhibited no periodic structure exceeding 5 Å but a new bond at 3.7 Å which was twice longer than a Ta—O/F bond (1.85 Å). It was inferred that the oxygen introduction resulted in forming an amorphous polyoxyfluoro tantalate unit including a Ta—O—Ta bond. Herein, oxygen (O) atoms might act as a linkage between Ta(O/F)₆ polyhedral sharing an edge, like the case of chlorides.

### Evaluation Example 4: Soft XAFS Profiles of Amorphous Solid Electrolytes of Synthesis Examples 1 and 6

FIG. 3(b) shows soft XAFS profiles of the amorphous solid electrolytes of Synthesis Examples 1 and 6.

In a TEY (Total Electron Yield) mode, soft XAS (O and F K-edges) measurement was performed with a 10D XAS_KIST beamline of PLS II (Pohang Light Source). All the XAS spectra were processed by using a Demeter software.

To further examine local structures of the amorphous solid electrolyte (Li₂TaOF₅) of Synthesis Example 6, the soft XAS measurement on the amorphous solid electrolyte (LiTaF₆) of Synthesis Example 1 and the amorphous solid electrolyte (Li₂TaOF₅) of Synthesis Example 6 was performed. The O and F K-edge spectra were expressed as relative energies to E0 (maximum first derivative of the pre-edge, FIG. 2b).

In the amorphous solid electrolyte (Li₂TaOF₅) of Synthesis Example 6, because O²⁻ and F⁻ (10 electrons) were isoelectric and exhibited similar ion radii, if coordinated to the same octahedral site, they should exhibit similar XANES characteristics. In particular, the F K-edge spectrum of the amorphous solid electrolyte (LiTaF₆) of Synthesis Example 1 and the O K-edge spectrum of the amorphous solid electrolyte (Li₂TaOF₅) of Synthesis Example 6 exhibited significantly similar profiles without a significant decrease in the pre-edge intensity, which means that the O atoms of the amorphous solid electrolyte (Li₂TaOF₅) of Synthesis Example 6 maintained a strong covalent bond with Ta within the octahedral coordination.

Based on the structural information of the amorphous solid electrolyte (Li₂TaOF₅) of Synthesis Example 6 including the PDF fitting, the soft XAS, and the like, it was reasonable to say that the amorphous solid electrolyte (Li₂TaOF₅) of Synthesis Example 6 had a main structure of multiple Ta(O/F)₆ octahedra connected by bridging oxygens and sharing corners.

### Evaluation Example 5: Charge/Discharge Characteristics and Cycle-life Characteristics of All-Solid-State Battery Cells

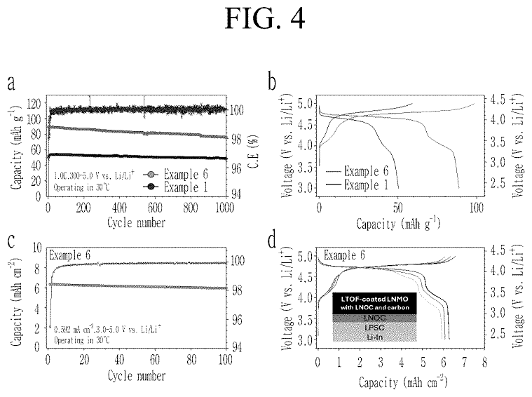

FIG. 4 shows (a, b) long-term cycle performances at 1.0 C of all-solid-state battery cells, to which the composite positive electrode active materials of Examples 1 and 6 were respectively applied, and their corresponding charge-discharge profiles and (c, d) discharge capacity and coulombic efficiency according to cycles of the all-solid-state battery cells, to which the composite positive electrode active materials of Examples 1 and 6 having an areal capacity of 6 mA cm 2 or more, when cycled at 0.1 C (0.592 mA cm 2) at room temperature, were respectively applied.

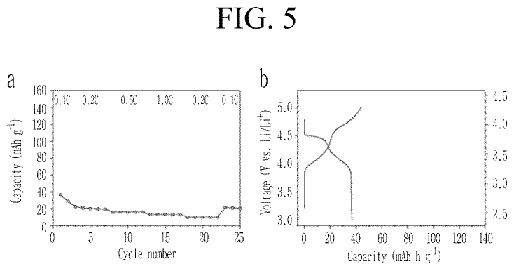

FIG. 5 shows (a, b) cell performance of an all-solid-state battery cell to which the positive electrode active material of Comparative Example 1 was applied and its corresponding charge-discharge profile.

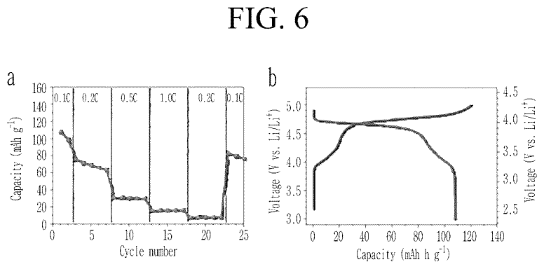

FIG. 6 shown (a, b) cell performance of an all-solid-state battery cell to which the positive electrode active material of Comparative Example 2 was applied and its corresponding charge-discharge profile.

(1) Manufacturing of all-Solid-State Battery Cells

A counter/reference electrode was prepared by mixing powders of In (99%, Sigma-Aldrich Co., Ltd.) and Li (FMC Lithium Corp.) to form Li—In with a nominal composition of Li0.5In, and then mixing it with Li6PS5Cl powder in a weight ratio of 8:2. A working electrode (positive electrode) mixture was prepared by manually mixing each positive electrode active material (from Example 1, Example 6, Comparative Example 1, or Comparative Example 2), a solid electrolyte (Li6PS5Cl), and a conductive agent (super C65) in a weight ratio of 70:27:3 using a mortar and a pestle.

To manufacture an all-solid-state battery cell, first, Li6PS5Cl powder (150 mg) was pressed at about 70 MPa to form a solid electrolyte layer. Then, the prepared working electrode mixture and the counter/reference electrode were placed on opposite sides of the solid electrolyte layer, and the entire assembly was pressed at about 380 MPa to fabricate an electrode assembly. The fabricated all-solid-state battery cell was tested while maintained under a pressure of about 70 MPa. The pressure was applied by tightening a torque wrench (TOHNICHI) to 100 kgf·cm², which corresponds to about 70 MPa as measured by a pressure sensor (load cell, BONGSHIN). A glass container was used for cell sealing.

(2) Charge/Discharge Characteristics and Cycle-Life Characteristics of all-Solid-State Battery Cells

Referring to (a) and (b) of FIG. 4, as a result of evaluating their cycling performances and charge-discharge profiles at 1.0 C within 3.0 to 5.0 V at 30° C., the all-solid-state battery cell to whose positive electrode the composite positive electrode active material of Example 6 was applied achieved a high ICE of 90.0%, initial discharge capacity of 88.8 mAh g⁻¹, and an excellent capacity retention rate of 85.8% after 1000 cycles.

The all-solid-state battery cell to whose positive electrode the composite positive electrode active material of Example 1 was applied exhibited a capacity retention rate of 96.5% after 1000 cycles (because of small volume change due to low charge/discharge depth) but limited discharge capacity of 55 mAh g⁻¹. This was because the composite positive electrode active material of Example 1 had lower ionic conductivity (9.20×10⁻¹⁰ S cm⁻¹) than that (1.08×10⁻⁶ S cm⁻¹) of the composite positive electrode active material of Example 6.

In practical applications, high positive electrode loading is essential to achieve significant area capacity. FIG. 4 (c) and (d) show performances of their high-mass loading ASSB (49.3 mgCAM cm⁻²) cycled with an area current of 0.592 mA cm⁻² at 30° C. Herein, each of the all-solid-state battery cells, to whose positive electrodes the composite positive electrode active materials of Examples 1 and 6 were respectively applied, achieved an initial coulombic efficiency (ICE) of 95.4% and initial discharge capacity of 6.3 mAh cm 2 (128.0 mAh g⁻¹). Furthermore, the high-mass ASSB exhibited a stable capacity retention rate and specific capacity (>5.9 mAh cm⁻² and >120.3 mAh g⁻¹) and a capacity retention rate of 94.0% at 100 cycles. This surpassed performance of each of the all-solid-state battery cells manufactured by respectively applying the positive electrode active materials of Comparative Examples 1 and 2, which was measured under the same condition.

### CONCLUSION

The composite positive electrode active material according to an embodiment represented by Examples 1 to 6 has excellent structural stability and electrochemical properties, and may greatly improve the charge/discharge characteristics and cycle-life characteristics of an all-solid-state battery cells using the composite positive electrode active material in the positive electrode.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

100: all-solid-state battery
200: positive electrode
201: positive electrode current collector
203: positive electrode active material layer
300: solid electrolyte layer
400: negative electrode
401: negative electrode current collector
403: negative electrode active material layer
500: elastic layer

What is claimed is:

1. A composite positive electrode active material for an all-solid-state battery, comprising
a positive electrode active material core and a coating layer on the core,
wherein the coating layer comprises an amorphous solid electrolyte represented by Chemical Formula 1: 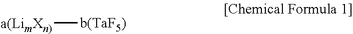
wherein, in Chemical Formula 1,
X is F, Cl, Br, I, O, OH, PF₆, BF₄, S, N, P, ClO₄, or CO₃;
m and n satisfy 1≤m≤2 and 1≤n≤2, respectively; and
a and b each satisfy 0.01≤a≤1 and 0.01≤b≤1.

2. The composite positive electrode active material of claim 1, wherein
LiₘXₙ is LiF, LiCl, LiBr, LiI, Li₂O, Li₂O₂, Li₂CO₃, LiOH, LiPF₆, LiBF₄, Li₂S, Li₃N, Li₃P, LiClO₄, or a combination thereof.

3. The composite positive electrode active material of claim 1, wherein the amorphous solid electrolyte represented by Chemical Formula 1 is formed by a process of mechanically milling a raw material mixture including LiX¹ (wherein, X¹═F, Cl, Br, I, or a combination thereof) and TaF₅.

4. The composite positive electrode active material of claim 3, wherein the raw material mixture further comprises Li₂O.

5. The composite positive electrode active material of claim 1, wherein the amorphous solid electrolyte represented by Chemical Formula 1 comprises LiTaF₆, Li_{1.2}TaO_{0.2}F_{5.8}, Li_{1.4}TaO_{0.4}F_{5.6}, Li_{1.6} TaO_{0.6}F_{5.4}, Li_{1.8} TaO_{0.8}F_{5.2}, Li₂TaOF₅, or a combination thereof.

6. The composite positive electrode active material of claim 1, wherein
a lithium ionic conductivity of the amorphous solid electrolyte represented by Chemical Formula 1 at 30° C. is greater than or equal to about 1.0×10⁻¹⁰ S/cm.

7. The composite positive electrode active material of claim 1, wherein
based on 100 parts by weight of the core,
the coating layer is included in an amount of about 1 part by weight to about 50 parts by weight.

8. The composite positive electrode active material of claim 1, wherein
the positive electrode active material comprises a compound having a spinel structure.

9. The composite positive electrode active material of claim 8, wherein
the positive electrode active material comprises a compound represented by Chemical Formula 2A: 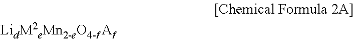
wherein, in Chemical Formula 2A,
M² is Al, Ni, Co, Mn, Zn, Cr, Mg, Sr, V, Ca, Ti, Y, Zr, Nb, Mo, Hf, Ta, W, Na, Sn, a rare-earth element, or a combination thereof,
A is F, Cl, Br, or I,
1≤d≤2, 0≤e<2, and 0≤f<4.

10. The composite positive electrode active material of claim 9, wherein the positive electrode active material comprises LiNi_{0.5}Mn_{1.5}O₄.

11. A positive electrode comprising a composite positive electrode active material,
wherein the composite positive electrode active material comprises positive electrode active material core and a coating layer on the core, and the coating layer comprises an amorphous solid electrolyte represented by Chemical Formula 1. 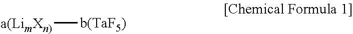
wherein, in Chemical Formula 1,
X is F, Cl, Br, I, O, OH, PF₆, BF₄, S, N, P, ClO₄, or CO₃;
m and n satisfy 1≤m≤2 and 1≤n≤2, respectively; and
a and b each satisfy 0.01≤a≤1 and 0.01≤b≤1.

12. The positive electrode of claim 11, wherein
the positive electrode further comprises a separate solid electrolyte, wherein the separate solid electrolyte is a halide-based solid electrolyte.

13. An all-solid-state battery comprising
the positive electrode of claim 11;
a negative electrode; and
a solid electrolyte layer between the positive electrode and the negative electrode.

14. The all-solid-state battery of claim 13, wherein
the solid electrolyte layer comprises a sulfide-based solid electrolyte, and
the sulfide-based solid electrolyte is an argyrodite-type sulfide-based solid electrolyte.

15. The all-solid-state battery of claim 13, wherein
a charge voltage of the solid-state battery is 4.5 V or higher, and the discharge voltage is 3.5 V or lower.
